(19) United States
(12) Patent Application Publication
(10) Pub. No.: US 2025/0317177 A1
(43) Pub. Date: Oct. 9, 2025

(54) CHANNEL STATE INFORMATION REFERENCE SIGNAL RESOURCE MAPPING

(71) Applicant: Lenovo (United States) Inc., Morrisville, NC (US)

(72) Inventor: Khaled Nafez Rauf Ardah, Ilmenau (DE)

(73) Assignee: Lenovo (United States) Inc., Morrisville, NC (US)

(21) Appl. No.: 19/080,344

(22) Filed: Mar. 14, 2025

Related U.S. Application Data
(60) Provisional application No. 63/574,853, filed on Apr. 4, 2024.

(51) Int. Cl. H04B 7/06; H04L 1/1607; H04L 5/00; H04L 5/14

(52) U.S. Cl. CPC H04B 7/0626; H04L 1/1614; H04L 5/0005; H04L 5/14

(57) ABSTRACT

Various aspects of the present disclosure relate to channel state information reference signal (CSI-RS) resource mapping. A UE receives a configuration message for CSI-RS resource settings that indicates one or more CSI-RS resources. At least one of the one or more CSI-RS resources includes multiple active CSI-RS parts and is associated with subband full-duplex (SBFD) symbols and downlink (DL) symbols, where SBFD symbols include both uplink (UL) and DL frequency subbands, and DL symbols include only DL frequency subband. The UE transmits, based at least in part on the configuration message, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

### RELATED APPLICATION

This application claims priority to U.S. Patent Application Ser. No. 63/574,853 filed Apr. 4, 2024 entitled “CHANNEL STATE INFORMATION REFERENCE SIGNAL RESOURCE MAPPING,” the disclosure of which is incorporated by reference herein in its entirety.

### TECHNICAL FIELD

The present disclosure relates to wireless communications, and more specifically to channel state information reference signal resource (CSI-RS) mapping.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration message for channel state information reference signal (CSI-RS) resource settings, wherein the configuration message indicates one or more CSI-RS resources, wherein at least one CSI-RS resource of the one or more CSI-RS resources comprises multiple active CSI-RS parts and is associated with subband full-duplex (SBFD) symbols and downlink (DL) symbols, and wherein SBFD symbols include both uplink (UL) and DL frequency subbands, and DL symbols include only DL frequency subband; transmit, based at least in part on the configuration message, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

A processor (e.g., a standalone processor chipset, or a component of a UE) for wireless communication is described. The processor may be configured to, capable of, or operable to perform one or more operations as described herein. For example, the processor may be configured to, capable of, or operable to receive a configuration message for CSI-RS resource settings, wherein the configuration message indicates one or more CSI-RS resources, wherein at least one CSI-RS resource of the one or more CSI-RS resources comprises multiple active CSI-RS parts and is associated with SBFD symbols and DL symbols, and wherein SBFD symbols include both UL and DL frequency subbands, and DL symbols include only DL frequency subband; transmit, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

A method performed or performable by a UE for wireless communication is described. The method may include receiving a configuration message for CSI-RS resource settings, wherein the configuration message indicates one or more CSI-RS resources, wherein at least one CSI-RS resource of the one or more CSI-RS resources comprises multiple active CSI-RS parts and is associated with SBFD symbols and DL symbols, and wherein SBFD symbols include both UL and DL frequency subbands, and DL symbols include only DL frequency subband; and transmitting, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

In some implementations of the UE, the processor, and the method described herein, the active CSI-RS parts are indicated via a bitmap or by assuming all configured CSI-RS parts are active. In some implementations of the UE, the processor, and the method described herein, the bitmap is associated with one or both of SBFD symbols or DL symbols. In some implementations of the UE, processor, and method described herein, the UE, processor, and method may further be configured to, capable of, performed, performable, or operable to receive the bitmap via a radio resource control (RRC) message or a DL control information (DCI) message.

In some implementations of the UE, processor, and method described herein, the bitmap is associated with at least one of a time pattern, a time window, or a time index set. In some implementations of the UE, processor, and method described herein, frequency resources of one or more of CSI-RS parts not confined within an associated DL subband are excluded when deriving the first CSI-RS frequency resource during the SBFD symbol. In some implementations of the UE, processor, and method described herein, an association between a CSI-RS part of the multiple active CSI-RS parts and a DL subband of a SBFD symbol is determined based at least in part on a location of a start resource block (RB) of the CSI-RS part.

In some implementations of the UE, processor, and method described herein, the UE, processor, and method may further be configured to, capable of, performed, performable, or operable to derive the second CSI-RS frequency resource during the DL symbol using a same techniques as used to derive the first CSI-RS frequency resource during the SBFD symbol. In some implementations of the UE, processor, and method described herein, the UE, processor, and method may further be configured to, capable of, performed, performable, or operable to derive the second CSI-RS frequency resource during the DL symbol by combining the multiple active CSI-RS parts.

In some implementations of the UE, processor, and method described herein, the second CSI-RS frequency resource derived during the DL symbol is characterized by a start RB of a lower CSI-RS part of the multiple active CSI-RS parts and a number of RBs calculated by summing a number of RBs of the multiple active CSI-RS parts. In some implementations of the UE, processor, and method described herein, the lower CSI-RS part is one of the multiple active CSI-RS parts associated with a minimum start RB.

In some implementations of the UE, processor, and method described herein, the UE, processor, and method may further be configured to, capable of, performed, performable, or operable to derive the second CSI-RS frequency resource during the DL symbol by including frequency resources between lower a CSI-RS part of the multiple active CSI-RS parts and higher CSI-RS part of the multiple active CSI-RS parts. In some implementations of the UE, processor, and method described herein, the lower CSI-RS part is one of the multiple active CSI-RS parts associated with a minimum start RB and the higher CSI-RS part is one of the multiple active CSI-RS parts associated with a highest RB index.

In some implementations of the UE, processor, and method described herein, the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts. In some implementations of the UE, processor, and method described herein, the number of RBs is calculated based at least in part on a number of RBs of a higher CSI-RS part of the multiple active CSI-RS parts, and a start RB of a lower CSI-RS part of the multiple active CSI-RS parts.

In some implementations of the UE, processor, and method described herein, the UE, processor, and method may further be configured to, capable of, performed, performable, or operable to receive an option indication that indicates which of multiple options to use to derive the second CSI-RS frequency resource during the DL symbols. In some implementations of the UE, processor, and method described herein, the UE, processor, and method may further be configured to, capable of, performed, performable, or operable to receive the option indication via a RRC message or a DCI message. In some implementations of the UE, processor, and method described herein, the option indication is associated with at least one of a time pattern, a time window, or a time index set.

An NE (e.g., a base station) for wireless communication is described. The NE may be configured to, capable of, or operable to perform one or more operations as described herein. For example, the NE may be configured to, capable of, or operable to transmit, to a UE, a configuration message for CSI-RS resource settings, wherein the configuration message indicates one or more CSI-RS resources, wherein at least one CSI-RS resource of the one or more CSI-RS resources comprises multiple active CSI-RS parts and is associated with SBFD symbols and DL symbols, and wherein SBFD symbols include both UL and DL frequency subbands, and DL symbols include only DL frequency subband; receive, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

A processor (e.g., a standalone processor chipset, or a component of a NE (e.g., a base station)) for wireless communication is described. The processor may be configured to, capable of, or operable to perform one or more operations as described herein. For example, the processor may be configured to, capable of, or operable to transmit, to a UE, a configuration message for CSI-RS resource settings, wherein the configuration message indicates one or more CSI-RS resources, wherein at least one CSI-RS resource of the one or more CSI-RS resources comprises multiple active CSI-RS parts and is associated with SBFD symbols and DL symbols, and wherein SBFD symbols include both UL and DL frequency subbands, and DL symbols include only DL frequency subband; receive, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

A method performed or performable by an NE (e.g., a base station) for wireless communication is described. The method may include transmitting, to a UE, a configuration message for CSI-RS resource settings, wherein the configuration message indicates one or more CSI-RS resources, wherein at least one CSI-RS resource of the one or more CSI-RS resources comprises multiple active CSI-RS parts and is associated with SBFD symbols and DL symbols, and wherein SBFD symbols include both UL and DL frequency subbands, and DL symbols include only DL frequency subband; and receiving, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

In some implementations of the NE, the processor, and the method described herein, the active CSI-RS parts are indicated via a bitmap or by assuming all configured CSI-RS parts are active. In some implementations of the NE, the processor, and the method described herein, the bitmap is associated with one or both of SBFD symbols or DL symbols. In some implementations of the NE, processor, and method described herein, the NE, processor, and method may further be configured to, capable of, performed, performable, or operable to transmit the bitmap via a RRC message or a DCI message.

In some implementations of the NE, the processor, and the method described herein, the bitmap is associated with at least one of a time pattern, a time window, or a time index set. In some implementations of the NE, the processor, and the method described herein, frequency resources of one or more of CSI-RS parts not confined within an associated DL subband are excluded when deriving the first CSI-RS frequency resource during the SBFD symbol. In some implementations of the NE, the processor, and the method described herein, an association between a CSI-RS part of the multiple active CSI-RS parts and a DL subband of a SBFD symbol is determined based at least in part on a location of a start RB of the CSI-RS part.

In some implementations of the NE, the processor, and the method described herein, the second CSI-RS frequency resource is derived during the DL symbol using a same techniques as used to derive the first CSI-RS frequency resource during the SBFD symbol. In some implementations of the NE, the processor, and the method described herein, the second CSI-RS frequency resource is derived during the DL symbol by combining the multiple active CSI-RS parts. In some implementations of the NE, the processor, and the method described herein, the second CSI-RS frequency resource derived during the DL symbol is characterized by a start RB of a lower CSI-RS part of the multiple active CSI-RS parts and a number of RBs calculated by summing a number of RBs of the multiple active CSI-RS parts.

In some implementations of the NE, the processor, and the method described herein, the lower CSI-RS part is one of the multiple active CSI-RS parts associated with a minimum start RB. In some implementations of the NE, the processor, and the method described herein, the second CSI-RS frequency resource is derived during the DL symbol by including frequency resources between lower a CSI-RS part of the multiple active CSI-RS parts and higher CSI-RS part of the multiple active CSI-RS parts.

In some implementations of the NE, the processor, and the method described herein, the lower CSI-RS part is one of the multiple active CSI-RS parts associated with a minimum start RB and the higher CSI-RS part is one of the multiple active CSI-RS parts associated with a highest RB index. In some implementations of the NE, the processor, and the method described herein, the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts.

In some implementations of the NE, the processor, and the method described herein, the number of RBs is calculated based at least in part on a number of RBs of a higher CSI-RS part of the multiple active CSI-RS parts, and a start RB of a lower CSI-RS part of the multiple active CSI-RS parts. In some implementations of the NE, processor, and method described herein, the NE, processor, and method may further be configured to, capable of, performed, performable, or operable to transmit an option indication that indicates which of multiple options to use to derive the second CSI-RS frequency resource during the DL symbols.

In some implementations of the NE, processor, and method described herein, the NE, processor, and method may further be configured to, capable of, performed, performable, or operable to transmit the option indication via a RRC message or a DCI message. In some implementations of the NE, processor, and method described herein, the option indication is associated with at least one of a time pattern, a time window, or a time index set.

### BRIEF DESCRIPTION OF THE DRAWINGS

FIG. 1 illustrates an example of a wireless communications system in accordance with aspects of the present disclosure.

FIGS. 2 and 3 illustrate scenarios for wireless communications in accordance with aspects of the present disclosure.

FIG. 4 illustrates an example contiguous frequency domain resource allocation (FDRA) of a CSI resource in accordance with aspects of the present disclosure.

FIG. 5 illustrates aperiodic trigger state defining a list of CSI report settings in accordance with aspects of the present disclosure.

FIG. 6 illustrates aperiodic trigger state indicating the resource set and QCL information in accordance with aspects of the present disclosure.

FIGS. 7 and 8 illustrate RRC configuration for non-zero power (NZP) CSI-RS/CSI-IM resources in accordance with aspects of the present disclosure.

FIG. 9 illustrates partial CSI omission PUSCH-Based CSI in accordance with aspects of the present disclosure.

FIG. 10 illustrates an example of a CSI-RS part confined within one downlink (DL) subband in accordance with aspects of the present disclosure.

FIG. 11 illustrates an example of a CSI-RS part unconfined within one DL subband in accordance with aspects of the present disclosure.

FIG. 12 illustrates an example of deriving a single CSI-RS resource in accordance with aspects of the present disclosure.

FIGS. 13, 14, and 15 illustrate examples of deriving a single CSI-RS resource during DL-only symbols in accordance with aspects of the present disclosure.

FIG. 16 illustrates an example of a UE in accordance with aspects of the present disclosure.

FIG. 17 illustrates an example of a processor in accordance with aspects of the present disclosure.

FIG. 18 illustrates an example of an NE in accordance with aspects of the present disclosure.

FIG. 19 illustrates a flowchart of a method performed by a UE in accordance with aspects of the present disclosure.

FIG. 20 illustrates a flowchart of a method performed by an NE in accordance with aspects of the present disclosure.

### DETAILED DESCRIPTION

In wireless communications systems, time division duplexing (TDD) and frequency division duplexing (FDD) are two duplexing modes used by current wireless networks. TDD uses the same carrier frequency but splits the time resources between the DL and uplink (UL) communications. FDD enables simultaneous UL and DL communications, but using different carrier frequencies. Full duplex (FD) mode enables simultaneous UL and DL communications over the same carrier frequency and same time resource. FD mode can bring gains or enhancements in terms of increasing the system capacity and coverage and/or reducing latency compared to the half-duplex TDD and FDD modes.

When using the same time and frequency resources for UL and DL communications, e.g., as in FD mode, self-interference (SI) and cross link interference (CLI) issues can arise. SI refers to situations where the transmitted DL/UL signal by a network node (e.g., an NE or a UE) leaks energy onto its received UL/DL signal. CLI refers to situations where the transmitted DL/UL signal by a network node (e.g., an NE or UE) leaks energy onto received UL/DL signal of a nearby node. Accordingly, to improve usage of the FD mode, SI and CLI are to be properly managed.

One solution to the SI and CLI issues is to split the frequency resources of a time resource into non-overlapping DL and UL subbands (SBs), where each subband includes one or more resource blocks (RBs). Such an approach can reduce the impact of SI and CLI and can be referred to as non-overlapping SBFD. It should be noted that a subband may also be referred to herein as a sub-band or sub band.

Another technique used in wireless communication systems is channel state information (CSI) estimation, which enables efficient transmission and reception schemes. For example, a network node (e.g., a gNB) acquires knowledge of CSI information, e.g., to determine efficient precoding/beamforming matrices (i.e., spatial filters), user and time-frequency resources scheduling, link-adaptation strategies, and so forth.

Currently, a CSI RS resource is allocated using a contiguous frequency domain resource allocation (FDRA) scheme in the form of “start RB” and “number of RBs”. However, in situations in which the total DL RBs within a SBFD slot are distributed over two DL subbands (SBs), the current contiguous FDRA scheme cannot allocate a single CSI RS resource over the two DL SBs. The techniques discussed herein describe solutions to enhance flexibility of CSI-RS frequency domain resource allocation to make resource allocation more general and applicable to both SBFD symbols and DL-only symbols.

In one or more implementations a CSI-RS resource for SBFD symbols includes multiple parts. A bitmap can be used to indicate which parts of the CSI-RS resources are active and used when deriving a single CSI-RS resource. The multiple parts from which the CSI-resource is derived need not be contiguous (e.g., there can be separations in frequency between the parts), and thus the CSI-RS resource may also be referred to as a non-contiguous CSI-RS resource. The bitmap is provided, for example, via a RRC message and/or a DCI message, and is associated with at least one of a time pattern, a time window, or a time index set. In some examples, the frequency resources of one or more parts of the CSI-RS resource are not confined within the associated DL subband and thus are excluded when deriving the single non-contiguous CSI-RS resource. This enhances flexibility of CSI-RS frequency allocation during SBFD symbols.

To generalize the CSI-RS frequency allocation between SBFD symbols and DL-only symbols, in one or more implementations a CSI-RS resource is for SBFD symbols and DL-only symbols and includes multiple parts. Different options are provided and used by the UE when deriving the single CSI-RS resource from the indicated CSI-RS parts. In some examples, the UE is provided with an option indication that indicates which option to apply for deriving the single CSI-RS resource during Dl-only symbols or slots. The option indication is provided, for example, via a RRC message and/or a DCI message, and is associated with at least one of a time pattern, a time window, or a time index set.

Reference is made herein to receiving, transmitting, or communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth. Similarly, other terms may be used interchangeably with transmitting (e.g., communicating, signaling, outputting, forwarding, and so forth), and other terms may be used interchangeably with receiving (e.g., communicating, retrieving, obtaining, and so forth).

Aspects of the present disclosure are described in the context of a wireless communications system.

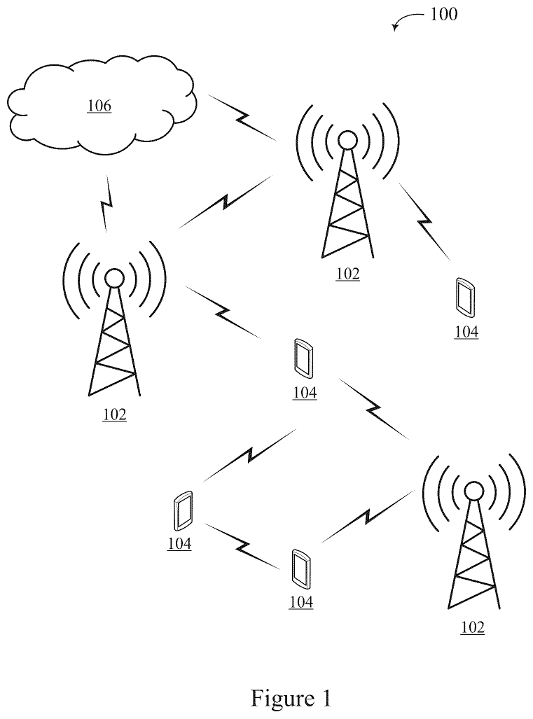

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., (μ=3), which includes 120 kHz subcarrier spacing.

In one or more implementations, one or more of the NEs 102 and the UEs 104 are operable to implement various aspects of the techniques described herein. For example, an NE 102 (e.g., a base station) communicates a configuration signal to a UE 104 including one or more CSI reporting settings, examples of which are described throughout this disclosure. The UE 104 receives the CSI reporting settings along with CSI-RS and generates a CSI report based at least in part on the CSI reporting settings and the CSI-RS. The CSI report includes information such as rank indicator (RI), precoding matrix indicator (PMI), and channel quality indicator (CQI) determined from the CSI-RS and based at least in part on the CSI reporting settings. The UE 104 transmits the CSI report to the NE 102 and the NE 102 can utilize information from the CSI report for various purposes, such as optimizing wireless communication between the NE 102 and the UE 104.

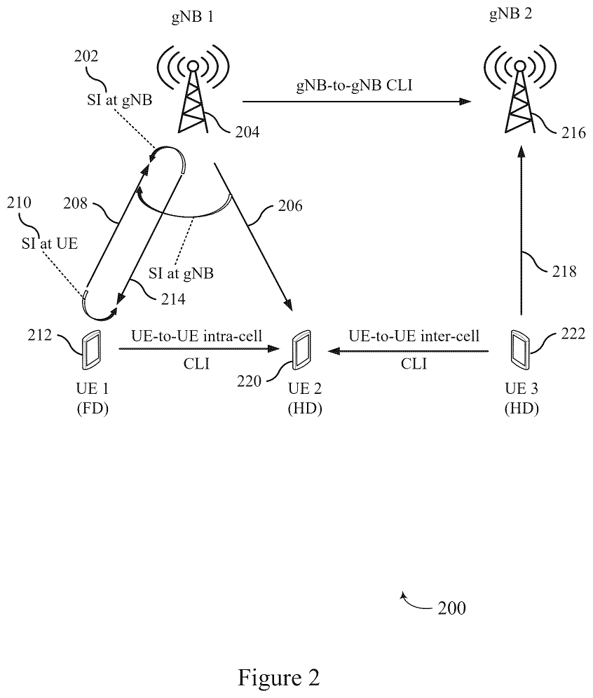

FIG. 2 illustrates a scenario 200 for wireless communications in accordance with aspects of the present disclosure. The scenario 200, for instance illustrates that cross-link interference (CLI) and self-interference (SI) can occur in a FD mode. In an FD mode, using the same time and frequency resources for UL and DL communications (e.g., as in FD mode) can cause SI and CLI issues as illustrated in the scenario 200.

SI refers to situations where the transmitted DL/UL signal by a network node (e.g., gNB or UE) leaks energy onto its received UL/DL signal as indicated above. As shown in FIG. 2 for example, for the SI 202 at gNB #1 204, the transmitted DL signal/channel 206 by gNB #1 204 leaks energy onto its received UL signal/channel 208, while for the SI 210 at the UB #1 212, the transmitted UL signal/channel 208 by UE #1 212 leaks energy onto its received DL signal/channel 214.

CLI refers to situations where the transmitted DL/UL signal by a network node (e.g., gNB or UE) leaks energy onto received UL/DL signal of a nearby node as indicated. As shown in FIG. 2, for example, for gNB-to-gNB CLI, e.g., at “victim” gNB #2 216, the transmitted DL signal/channel 206 by “aggressor” gNB #1 204 leaks energy onto the received UL signal/channel 218 by “victim” gNB #2 216. On the other hand, for UE-to-UE CLI, e.g., at “victim” UE #2 220, for example, the transmitted UL signals/channels 208 and 218 by “aggressors” UE #1 212 and UE #3 222 leaks energy onto received DL signal/channel 206 at “victim” UE #2 220.

To improve usage of the FD mode, SI and CLI are to be properly managed. One solution to the SI and CLI issues is to split the frequency resources of a time resource into non-overlapping DL and UL subbands (SBs), where each subband includes one or more resource blocks (RBs). Such an approach can reduce the impact of SI and CLI and can be referred to as non-overlapping SBFD. It should be noted that a subband may also be referred to as a sub-band or sub band.

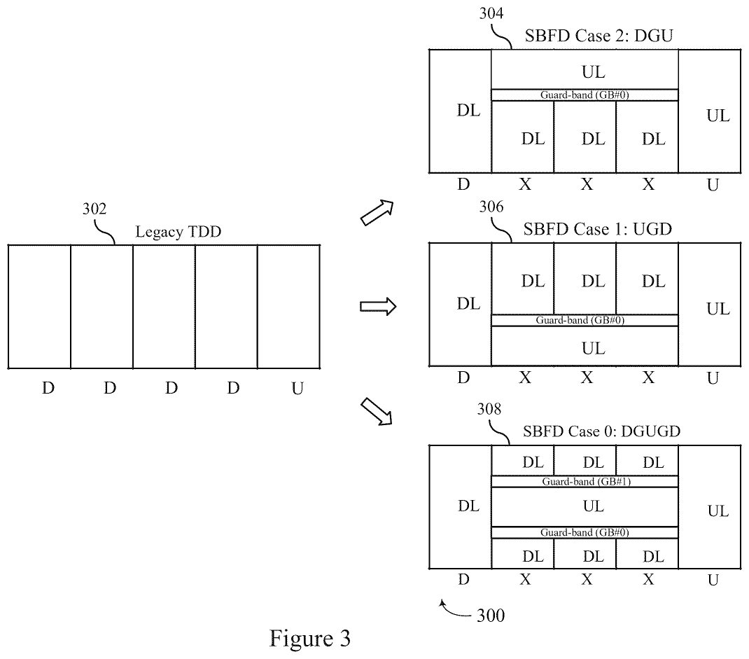

FIG. 3 illustrates a scenario 300 for wireless communications in accordance with aspects of the present disclosure. The scenario 300, for example, illustrates time slot resources in a legacy TDD mode with a legacy TDD-based configuration 302 versus three different FD mode configurations 304, 306, and 308. In time domain, for instance, some of the time resources (e.g., symbols or slots) may be used for SBFD communications (e.g., slots labeled ‘X’), while others can be used for half-duplex (HD) DL (e.g., slots labeled ‘D’) or UL (e.g., slots labeled ‘U’) communications. As illustrated in FIG. 3, the time-domain resources (symbols/slots) with UL and DL SBs can also be referred to herein as “SBFD symbols/slots” (labeled ‘X’), and the DL-only/UL-only symbols/slots, e.g., without UL or DL SBs, respectively, can be referred herein as “non-SBFD symbols/slots.” One scheme to overcome issues encountered by the legacy TDD scheme (e.g., reduced UL coverage, reduced UL capacity, and increased UL latency) is to split the frequency domain resources of one or more of DL and/or flexible (F) symbols/slots into non-overlapping DL and UL sub-bands and therefore increase the allocated time and frequency resources of UL communications.

FIG. 3 shows reconfiguration examples of a DDDDU legacy TDD slot configuration in a legacy TDD-based configuration 302 into three DXXXU SBFD slot configurations 304, 306, and 308, where the frequency domain of X slots (e.g., SBFD slots) is divided into non-overlapping DL and UL sub-bands. As illustrated, an SBFD-based configuration 304, 306, or 308 allocates more UL resources to UL communications as compared to the legacy TDD-based configuration 302, which can increase the UL communications capacity and coverage. Moreover, the UL frequency resources with SBFD-based configurations 304, 306, and 308 are available starting from slot #1 (e.g., the first slot labeled ‘X’) as opposed to the legacy TDD-based configuration 302, where the UL frequency resources are only available at slot #4 (e.g., the slot labeled ‘U’). Thus, the SBFD-based configurations 304, 306, and 308 facilitate improving or reducing the UL communications latency as compared to the legacy TDD-based configuration 302.

In wireless communication systems, channel state information (CSI) estimation enables efficient transmission and reception schemes. For example, a network node (e.g., a gNB) acquires knowledge of CSI information, e.g., to determine efficient precoding/beamforming matrices (i.e., spatial filters), user and time-frequency resources scheduling, link-adaptation strategies, and so forth.

In 5G NR, a UE could be configured to report some CSI quantities to its serving network node(s), depending on the configuration, including RI, PMI, CQI, etc. To facilitate this, in examples, a UE can be configured by its serving network node(s) with a set of CSI report settings (e.g., CSI-ReportConfig) and a set of CSI reference signals (RSs) resource settings (e.g., CSI-ResourceConfig), where each CSI report setting is associated with one or more of CSI resource settings for either channel measurement or interference measurement.

In examples, a configured CSI report setting defines the content of the CSI report in terms of (1) what CSI quantities to report (e.g., RI, PMI, CQI, etc.), (2) the frequency granularity of reported information (e.g., wideband reporting or sub-band reporting), and (3) the time domain behavior of reported information (e.g., periodic, aperiodic, or semi-persistent reporting). It is noted that, in some examples, the sub-band for CSI reporting has a different definition with respect to UL and DL sub-bands in the SBFD mode.

In examples, a CSI resource setting defines the CSI resources in terms of (1) by and/or over which resources the CSI information to be computed (e.g., NZP CSI-RS and/or CSI interference measurement (IM) resources), (2) the time domain behavior of CSI resources (e.g., periodic, aperiodic, or semi-persistent reporting), 3) the time domain resources over which the CSI resources are allocated (e.g., symbols/slots indexes and/or slots/symbols offset), and (4) the frequency domain resources over which the CSI resources are allocated (e.g., on every RB or on every other RB).

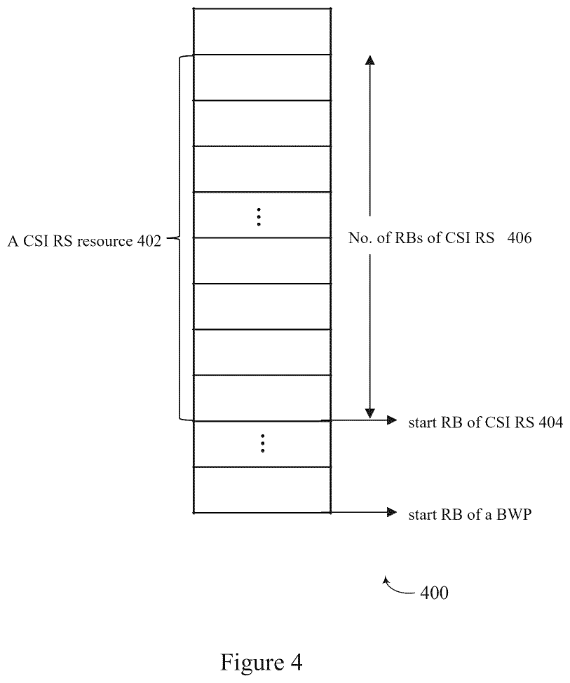

FIG. 4 illustrates an example 400 of contiguous FDRA of a CSI resource in accordance with aspects of the present disclosure. In examples, a CSI-RS resource 402 is allocated using a contiguous frequency domain resource allocation (FDRA) scheme in the form of “start RB” 404 and “number of RBs” 406, as exemplified in FIG. 4. However, as exemplified by the SBFD Case 0 of FIG. 3 (SBFD-based configuration 308), the total DL RBs within a SBFD slot (i.e., an X slot of SBFD-based configuration 308) are distributed over two DL SBs, and therefore, current contiguous FDRA schemes may be unable to allocate a single CSI-RS resource over the two DL SBs. Several options may be used to solve this issue.

Specifically, one option to solve this issue is by configuring one CSI RS resource with non-contiguous FDRA across two DL subbands, e.g., the CSI-RS resource includes two parts, one for each DL subband, which uses a new RRC structure compared to current techniques. However, a current CSI-RS resource provided in accordance with this option is only applicable to SBFD symbols and cannot be directly mapped to non-SBFD symbols. With reference to a single CSI-RS resource configuration across SBFD symbols and non-SBFD symbols, the techniques discussed herein provide solutions to enhance flexibility of CSI-RS frequency domain resource allocation and make CSI-RS frequency domain resource allocation more general and applicable to both SBFD symbols and DL-only symbols.

The frequency resource allocation for CSI-RS across DL subbands for SBFD-aware UEs considering the following options is taken into consideration. Option 1: two contiguous CSI-RS resources that are linked; Option 2: one CSI-RS resource; Option 2-1: non-contiguous CSI-RS resource allocation; Option 2-2: One contiguous CSI-RS resource allocation with non-contiguous CSI-RS resource derived by excluding frequency resources outside DL subband(s).

For these options, for frequency resource allocation for CSI-RS across DL subbands for SBFD-aware UEs, the following observations are taken into consideration. For all the options, there is no impact on CSI-RS sequence generation. Option 1 involves additional signaling to link two CSI-RS resources in two DL subbands. Option 2-1 involves new RRC structure to configure non-contiguous RBs for one CSI-RS resource, which may involve additional signaling overhead. Option 2-2 can reuse the existing signaling design for CSI-RS resource configuration. Option 2-2 can be used to resolve the potential unaligned boundaries between CSI-RS resource configuration and SBFD subbands. UE complexity due to UE capability of maximum number of configured CSI-RS resources, as well as processing non-contiguous CSI-RS, are taken into consideration.

The following provides a summary of NR codebook types. For NR Rel. 15 Type-II codebook, assume the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band consists of a set of resource blocks (RBs), each RB consisting of a set of subcarriers. Considering dual-polarization, there are 2N₁N₂ CSI-RS ports are utilized to enable DL channel estimation with high resolution for NR Rel. 15 Type-II codebook. In order to reduce feedback overhead in UL, a Discrete Fourier transform (DFT)-based transformation is used to project the channel onto L spatial beams (shared by both polarizations) where L<N₁N₂. In the sequel the indices of the L beams are referred as the Spatial Domain (SD) basis indices. The magnitude and phase values of the 2L linear combination coefficients for each sub-band are fed back to the gNB as part of the CSI report. The 2N₁N₂×N₃ codebook per layer/takes on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ are “oversampling factors”, assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the Z selected columns in B are reported, along with the oversampling index taking on O₁O₂ values. Note that W_{2,1} are independent across different layers.

For NR Rel. 15 Type-II Port Selection Codebook, only K (where K≤2N₁N₂) beamformed CSI-RS ports are utilized in DL transmission, in order to reduce complexity. The K×N₃ codebook matrix per layer takes on the form.

$${W}_{l} = {W}_{1}^{PS} {W}_{2 , l} .$$

Here, W_{2,1} follow the same structure as the conventional NR Rel. 15 Type-II Codebook and are layer specific. W₁^{PS} is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the ith location. Here d_{PS} is a radio resource control (RRC) parameter which takes on the values {1,2,3,4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback report. W₁^{PS} is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 0\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, where a phase coupling value is reported for each sub-band, e.g., Wat is 2×N3, with the first row equal to [1, 1, . . . , 1] and the second row equal to [e^{j2πØ}^{₀}, . . . , e^{j2π└}^{_{Na−1}}]. Under specific configurations, ϕ0=ϕ1 . . . =ϕ, e.g., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

For NR Rel. 16 Type-II Codebook, assume the gNB is equipped with a two-dimensional (2D) antenna array with N₁, N₂ antenna ports per polarization (N₁ being the horizontal and N₂ the vertical dimension of the array). In the frequency domain, communication occurs over N3 PMI sub-bands, where a sub-band consists of a set of RBs, each RB consisting of a set of subcarriers. Considering dual-polarization, there are 2N₁/N₂ CSI-RS ports are utilized to enable DL channel estimation with high resolution for NR Rel. 16 Type-II codebook. In order to reduce feedback overhead in UL, a DFT-based transformation is used to project the channel onto L spatial beams (shared by both polarizations) where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f,l} is an N₃×M matrix (M<N₃) with columns selected from a critically-sampled size-N₃ DET matrix, as follows:

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns in B are reported, along with the oversampling index taking on O1O2 values. Similarly, for W_{f,l}, only the indices of the M selected columns out of the predefined size-N₃ DFT matrix are reported. In the sequel the indices of the M dimensions are referred to as the selected Frequency Domain (FD) basis indices. Hence, L, M represent the equivalent spatial and frequency dimensions after compression, respectively. Finally, the 2L×M matrix \tilde{W}_{2,l} represents the linear combination coefficients (LCCs) of the spatial and frequency DFT-basis vectors of layer l. Both \tilde{W}_{2,l}, Wf,l are selected independent for different layers. Amplitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients of a theoretical design.

For NR Rel. 16 Type-II Port Selection Codebook, only K (where K≤2N₁N₂) beamformed CSI-RS ports are utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and Wf,l follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

The NR Rel. 17 Type-II Port Selection Codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix W̅₁^{PS} supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉ bits$$

are used to identify the K/2 selected ports per polarization, where this selection is common across all layers. Here, \tilde{W}_{2,l} and W_{f,l} follow the same structure as the conventional NR Rel. 16 Type-II Codebook, however Mis limited to {1,2} only, with the network configuring a window of size N∈{2,4} for M=2. Moreover, the bitmap is reported unless 6=1 and the UE reports all the coefficients for a rank up to a value of two.

For CSI reporting the codebook report is partitioned into two parts based on the priority of information reported. Each part is encoded separately (Part I has a possibly higher code rate). Below we list the parameters for NR Rel. 16 Type-II codebook.

For content of a CSI report:
Part 1: RI+CQI+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning is required to allow dynamic reporting size for codebook based on available resources in the UL phase.

Also Type-II codebook is based on aperiodic CSI reporting, and only reported in physical UL shared channel (PUSCH) via DL control information (DCI) triggering (one exception). Type-I codebook can be based on periodic CSI reporting (e.g., physical UL control channel (PUCCH)) or semi-persistent CSI reporting (PUSCH or PUCCH) or aperiodic reporting (PUSCH).

For priority reporting for CSI Part 2, note that multiple CSI reports may be transmitted with different priorities, as shown in Table 1 below. The priority of the N_{Rep} CSI reports are based on the following:

A CSI report corresponding to one CSI reporting setting for one cell may have higher priority compared with another CSI report corresponding to one other CSI reporting setting for the same cell.

CSI reports intended to one cell may have higher priority compared with other CSI reports intended to another cell.

CSI reports may have higher priority based on the CSI report content. For example, CSI reports carrying Layer 1 reference signal received power (L1-RSRP) information have higher priority.

CSI reports may have higher priority based on their type. For example, whether the CSI report is aperiodic, semi-persistent or periodic, and whether the report is sent via PUSCH or PUCCH, may impact the priority of the CSI report.

In light of these, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting setting index, and Mₛ: Maximum number of CSI reporting settings
c: Cell index, and N_{cells}: Number of serving cells
k: 0 for CSI reports carrying L1-RSRP or Layer 1 signal-to-interference-and-noise ratio (L1-SINR), 1 otherwise;
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI

Priority 0:
For CSI reports 1 to N_{Rep}, Group 0 CSI for CSI reports
configured as ‘typeII-r16’ or ‘typeII-PortSelection-r16’;
Part 2 wideband CSI for CSI reports configured
otherwise
Priority 1:
Group 1 CSI for CSI report 1, if configured as ‘typeII-
r16’ or ‘typeII-PortSelection-r16’; Part 2 subband CSI of
even subbands for CSI report 1, if configured otherwise
Priority 2:
Group 2 CSI for CSI report 1, if configured as ‘typeII-
r16’ or ‘typeII-PortSelection-r16’; Part 2 subband CSI of
odd subbands for CSI report 1, if configured otherwise
Priority 3:
Group 1 CSI for CSI report 2, if configured as ‘typeII-
r16’ or ‘typeII-PortSelection-r16’; Part 2 subband CSI of
even subbands for CSI report 2, if configured otherwise
Priority 4:
Group 2 CSI for CSI report 2, if configured as ‘typeII-
r16’ or ‘typeII-PortSelection-r16’. Part 2 subband CSI of
odd subbands for CSI report 2, if configured otherwise
.
.
.
Priority 2N_{Rep} − 1:
Group 1 CSI for CSI report N_{Rep}, if configured as
‘typeII-r16’ or ‘typeII-PortSelection-r16’; Part 2 subband
CSI of even subbands for CSI report N_{Rep}, if configured
otherwise
Priority 2N_{Rep}:
Group 2 CSI for CSI report N_{Rep}, if configured as
‘typeII-r16’ or ‘typeII-PortSelection-r16’; Part 2 subband
CSI of odd subbands for CSI report N_{Rep}, if configured
otherwise

For triggering aperiodic CSI reporting on PUSCH, a UE is to report the needed CSI information for the network using the CSI framework in NR Release 15. The triggering mechanism between a report setting and a resource setting can be summarized in Table 2 below.

TABLE 2
Triggering mechanism between a report setting and a resource setting

| | | | | Access |
|---|---|---|---|---|
| | | | | Point |
| | | Periodic CSI | Semi-Persistent (SP) CSI | (AP) CSI |
| | | reporting | reporting | Reporting |
| Time Domain | Periodic CSI-RS | RRC configured | MAC control element (CE) | DCI |
| Behavior of | | | (PUCCH) | |
| Resource Setting | | | DCI (PUSCH) | |
| | SP CSI-RS | Not Supported | MAC CE (PUCCH) | DCI |
| | | | DCI (PUSCH) | |
| | AP CSI-RS | Not Supported | Not Supported | DCI |

Moreover,
All associated Resource Settings for a CSI Report Setting are to have same time domain behavior.
Periodic CSI-RS/interference management (IM) resource and CSI reports are always assumed to be present and active once configured by RRC
Aperiodic and semi-persistent CSI-RS/IM resources and CSI reports needs to be explicitly triggered or activated.
Aperiodic CSI-RS/IM resources and aperiodic CSI reports, the triggering is done jointly by transmitting a DCI Format 0-1.
Semi-persistent CSI-RS/IM resources and semi-persistent CSI reports are independently activated.

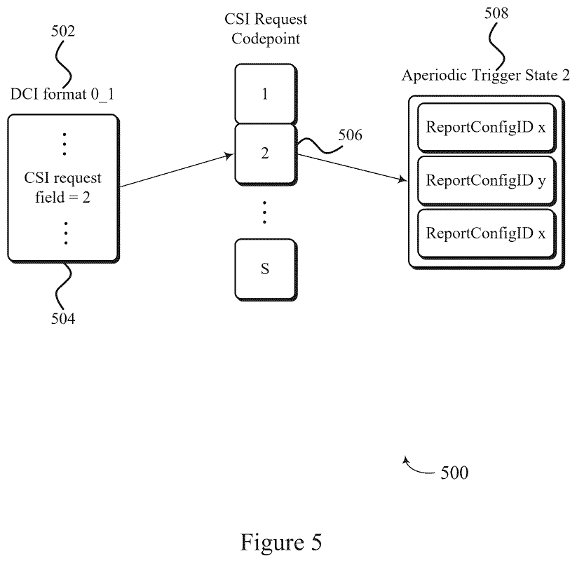

FIG. 5 illustrates aperiodic trigger state 500 defining a list of CSI report settings in accordance with aspects of the present disclosure. For aperiodic CSI-RS/IM resources and aperiodic CSI reports, the triggering is done jointly by transmitting a DCI Format 0-1 502. The DCI Format 0_1 502 contains a CSI request field (0 to 6 bits) 504. A non-zero request field points to a so-called aperiodic trigger state configured by RRC. For example, a CSI request field 2 points to a CSI request codepoint 506, which points to aperiodic trigger state 508. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi co-location (QCL) source to use is also configured in the aperiodic trigger state. The UE assumes that the resources used for the computation of the channel and interference can be processed with the same spatial filter e.g. quasi-co-located with respect to “QCL-TypeD.”

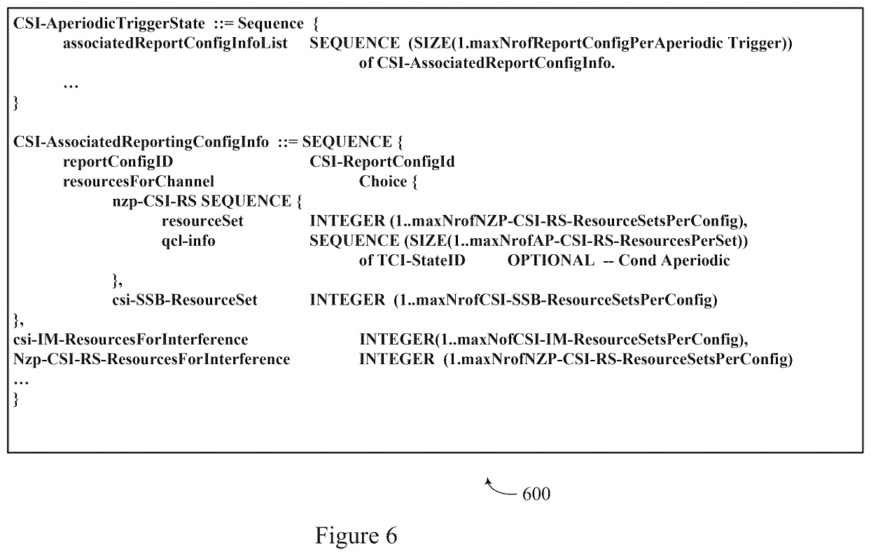

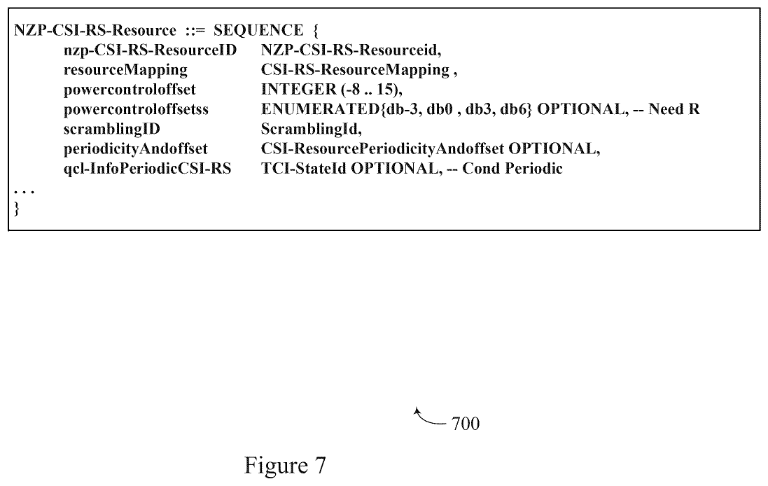

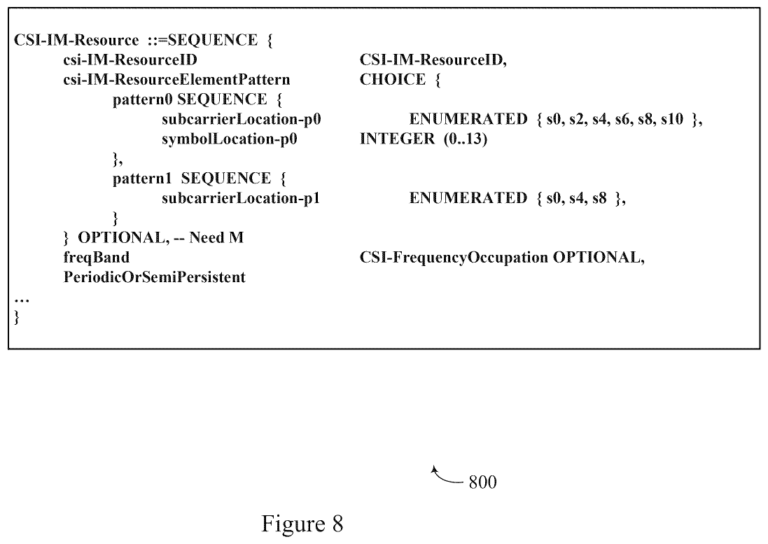

FIG. 6 illustrates at 600 aperiodic trigger state indicating the resource set and QCL information in accordance with aspects of the present disclosure. FIGS. 7 and 8 illustrate RRC configuration for NZP-CSI-RS/CSI-IM resources in accordance with aspects of the present disclosure. For instance, 700 illustrates RRC configuration for NZP-CSI-RS Resource and 800 illustrates RRC configuration for CSI-IM-Resource.

Table 3 summarizes the type of UL channels used for CSI reporting as a function of the CSI codebook type.

TABLE 3
UL channels used for CSI reporting as a function of the CSI codebook type

| | Periodic CSI reporting | SP CSI reporting | AP CSI reporting |
|---|---|---|---|
| Type I Wideband | PUCCH Format 2, 3, 4 | PUCCH Format 2 | PUSCH |
| (WB) | | PUSCH | |
| Type I Subband | | PUCCH Format 3, 4 | PUSCH |
| (SB) | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case UL control information (UCI) payload size design would result in large overhead. CSI Part 1 has a fixed payload size (and can be decoded by the gNB without prior information) and contains the following:
RI (if reported), channel state information reference signal (CRI) (if reported) and CQI for the first codeword,
number of non-zero wideband amplitude coefficients per layer for Type II CSI feedback on PUSCH.

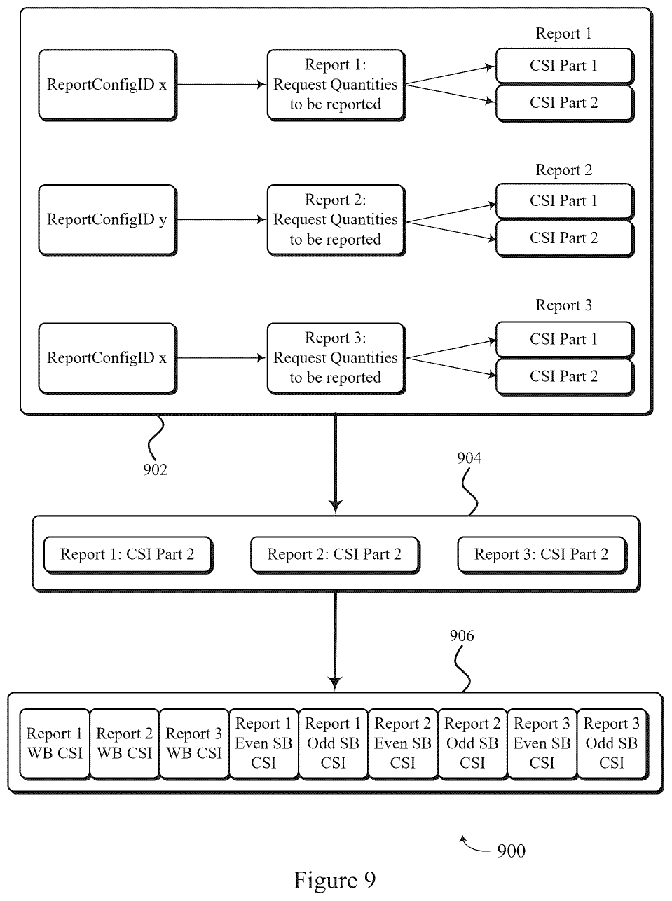

FIG. 9 illustrates a scenario 900 for partial CSI omission PUSCH-Based CSI in accordance with aspects of the present disclosure. FIG. 9 illustrates, for example, Rel. 15 PUSCH-Based CSI. The scenario 900, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 902 defines 3 report settings x, y, and z, then the CSI part is reordered across CSI reports 904, resulting in the aperiodic CSI reporting for CSI part 2 906 ordered as indicated in FIG. 9.

As mentioned earlier, CSI reports are prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

For CQI reporting a CSI report may include a CQI report quantity corresponding to channel quality assuming a target maximum transport block error rate, which indicates a modulation order, a code rate and a corresponding spectral efficiency associated with the modulation order and code rate pair. Examples of the maximum transport block error rates are 0.1 and 0.00001. The modulation order can vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate and efficiency is provided in Table 4 below, as follows.

A CQI value may be reported in two formats: a wideband format, where one CQI value is reported corresponding to each physical DL shared channel (PDSCH) transport block, and a subband format, where one wideband CQI value is reported for the entire transport block, in addition to a set of subband CQI values corresponding to CQI subbands on which the transport block is transmitted. CQI subband sizes are configurable, and depends on the number of physical resource blocks (PRBs) in a bandwidth part, as shown in Table 5.

TABLE 4
Example of a 4-bit CQI table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 640AM | 948 | 5.5547 |

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each sub-band s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6 as follows.

TABLE 6
Mapping sub-band differential CQI value to offset level

| Sub-band differential | |
|---|---|
| CQI value | Offset level |
| 0 | 0 |
| 1 | 1 |
| 2 | ≥2 |
| 3 | ≤−1 |

Also, note that multiple tables corresponding to mapping CQI indices to modulation and coding schemes may exist. For instance, Table 7 below may correspond to a first CQI table with modulation and coding schemes that correspond to enhanced Mobile BroadBand (eMBB)-based transmission, whereas Table 8 below of the CQI may correspond to a first CQI table with modulation and coding schemes that correspond to ultra-reliable low-latency communication (URLLC)-based transmission. Note that eMBB-based DL transmission and URLLC-based DL transmission correspond to two different thresholds of transport block error probability, where the threshold of the transport block error probability corresponding to the URLLC-based DL transmission, e.g., 0.00001 is lower than the threshold of the transport block error probability corresponding to the eMBB-based DL transmission, e.g., 0.1.

TABLE 7
CQI Table corresponding to eMBB-based DL transmission

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 8
CQI Table corresponding to URLLC-based DL transmission

| CQI | | code rate × | |
|---|---|---|---|
| index | modulation | 1024 | efficiency |

| | |
|---|---|
| 0 | out of range |

| | | | |
|---|---|---|---|
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

In one or more implementations, a UE receives, from its serving network node (e.g., a serving gNB), a CSI-RS resource configuration message containing one or more of CSI RS resource settings, where one or more of the CSI-RS resource settings are intended for SBFD symbols, e.g., X symbols or slots defined and shown in FIG. 3, where the frequency resources are divided into K+N non-overlapping subbands: K≥1 UL subbands and N≥1 DL subbands.

In some examples, a CSI-RS resource intended for SBFD symbols subdivided by N DL subbands is configured with M≤N CSI-RS frequency resource location settings, where each setting defines a part of the CSI-RS resource and is characterized by a start RB and a number of RBs.

With respect to active or inactive CSI-RS parts, in one or more implementations the M parts of CSI-RS resource are assumed active, where a single CSI-RS resource is formed by combining the M CSI-RS parts. Additionally or alternatively, the UE receives a bitmap indicating the activated and deactivated CSI-RS parts, where a single CSI-RS resource is formed by combining the activated CSI-RS parts. In some examples, the bitmap is provided within the RRC configuration message. In some other examples, the bitmap is provided dynamically via a DCI message. In yet other examples, the bitmap is associated with at least one of a time pattern, a time window (period), or a time index set.

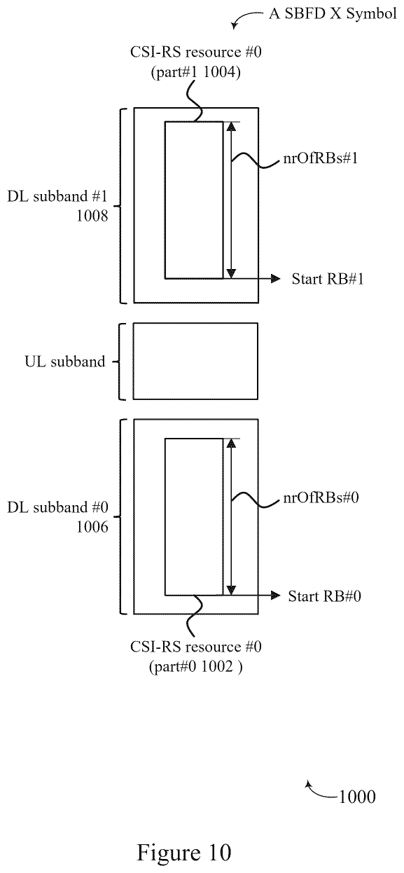

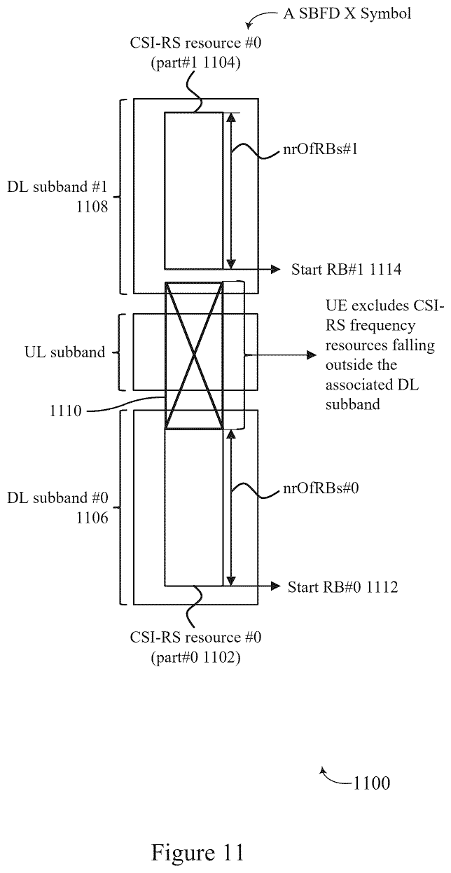

FIG. 10 illustrates an example 1000 of a CSI-RS part confined within one DL subband in accordance with aspects of the present disclosure. FIG. 11 illustrates an example 1100 of a CSI-RS part unconfined within one DL subband in accordance with aspects of the present disclosure. FIGS. 10 and 11 both illustrate examples of a non-contiguous CSI-RS resource for SBFD X symbols formed by two contiguous CSI-RS resource parts.

With respect to a CSI-RS part confined or unconfined within one DL subband, in one or more implementations, as illustrated in FIG. 10, the frequency resources of each CSI-RS part 1002 and 1004 are confined within one DL subband frequency resources 1006 and 1008, respectively. Additionally or alternatively, as illustrated in FIG. 11, the frequency resources of one or more CSI-RS parts 1102 and 1104 are not confined within one DL subband frequency resources 1106 and 1108, respectively, where the UE forms a single CSI-RS resource by first, excluding the frequency resources 1110 of the CSI-RS parts falling outside the associated DL subband frequency resource 1106, and then combining the remaining frequency resources of activated CSI-RS parts, where the UE assumes that the association between a CSI-RS part and a DL subband is determined based on the location of the start RB 1112 (for CSI-RS part 1102) and 1114 (for CSI-RS part 1104, as illustrated in FIG. 11.

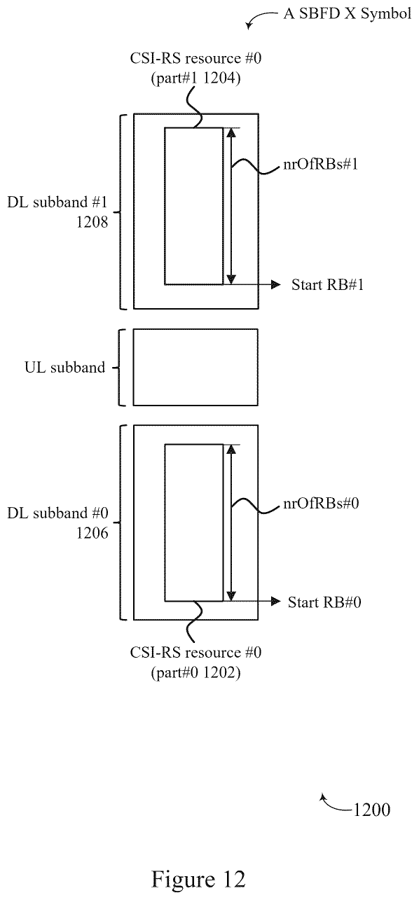

FIG. 12 illustrates an example 1200 of deriving a single CSI-RS resource in accordance with aspects of the present disclosure. The example 1200 illustrates a non-contiguous CSI-RS resource for SBFD X symbols formed by two contiguous CSI-RS resource parts. As illustrated in the example 1200, the frequency resources of one or more CSI-RS parts 1202 and 1204 are derived during DL-only symbols (e.g., DL subband frequency resources 1206 and 1208, respectively).

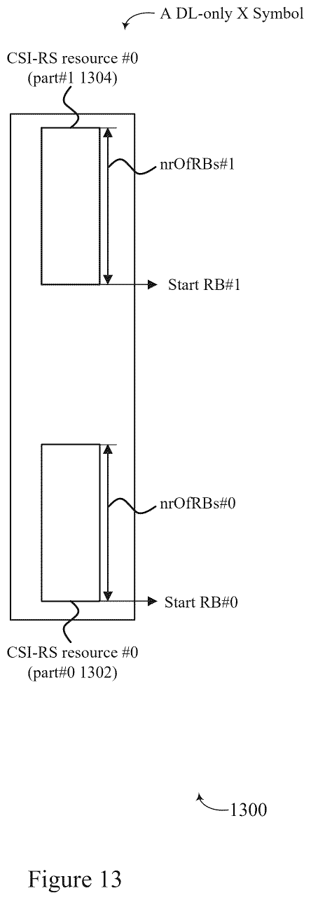

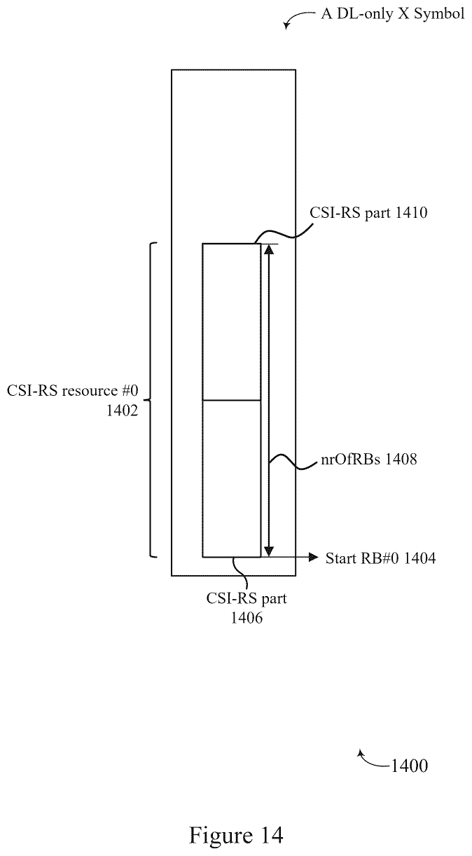

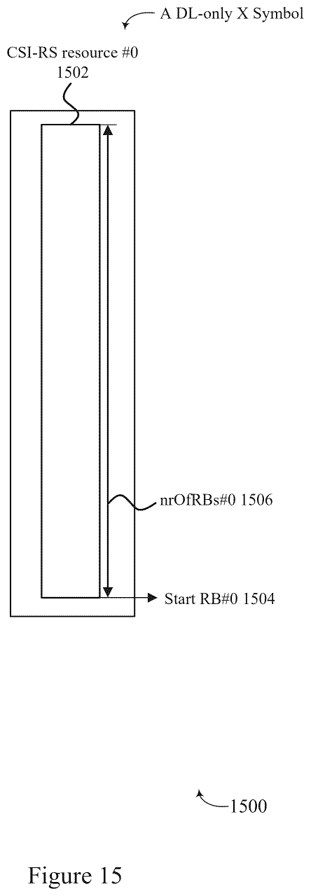

FIGS. 13, 14, and 15 illustrate examples of deriving a single CSI-RS resource during DL-only symbols in accordance with aspects of the present disclosure. The example 1300 of FIG. 13 illustrates a scenario where a same non-contiguous CSI-RS resource for SBFD X symbols is used during DL-only symbols. The example 1400 of FIG. 14 illustrates a scenario where a contiguous CSI-RS resource for DL-only symbols is formed by combining the two parts of the non-contiguous CSI-RS resource for SBFD X symbols. The example 1500 of FIG. 15 illustrates a scenario where a contiguous CSI-RS resource for DL-only symbols is formed by including the frequency resources between the two parts of the non-contiguous CSI-RS resource for SBFD X symbols.

In one or more implementations, the UE receives, from its serving network node (e.g., a serving gNB), a CSI-RS resource configuration message containing one or more CSI RS resource settings, where one or more of the CSI-RS resource settings intended for both SBFD symbols is also intended for DL-only symbols, e.g., the D symbols or slots defined and shown in FIG. 3, where each CSI-RS resource intended for SBFD symbols and DL-only symbols is configured with M≤N CSI-RS frequency resource location settings, where each setting defines a part of the CSI-RS resource and is characterized by a start RB and a number of RBs.

During the SBFD symbols, as illustrated in example 1200 of FIG. 12, the UE derives the single CSI-RS resources as discussed above.

During the DL-only symbols, the UE uses one or more of the following options (illustrated in example 1300 of FIG. 13, example 1400 of FIG. 14, and example 1500 of FIG. 15) to derive a single CSI-RS resource.

As illustrated in the example 1300 of FIG. 13, in one or more implementations the UE derives the single contiguous or non-contiguous CSI-RS resource during DL-only symbols using the same method as in SBFD X symbols. The frequency resources exclusion step as illustrated in the example 1100 of FIG. 11 is not applicable here, since the frequency resources of DL-only symbols are not subdivided into different DL/UL subbands. As illustrated in the example 1300, the frequency resources of one or more CSI-RS parts 1202 and 1204 are derived during a DL-only symbols.

As illustrated in the example 1400 of FIG. 14, in one or more implementations the UE derives a single contiguous CSI-RS resource 1402 during DL-only symbols using a start RB 1404 of a lower CSI-RS part 1406 and by combining the number of RBs 1408 of M active CSI-RS parts (in the illustrated example M=2 (lower CSI-RS part 1406 and upper CSI-RS part 1410)). As illustrated in the example 1400, the derived CSI-RS resource is characterized by Start RB #0 1404 and nrOfRBs 1408=noOfRBs #0 (the number of RBs in lower CSI-RS part 1406)+noOfRBs #1 (the number of RBs in upper CSI-RS part 1410).

As illustrated in the example 1500 of FIG. 15, in one or more implementations the UE derives a single contiguous CSI-RS resource 1502 during DL-only symbols by including the frequency resources between the lower CSI-RS part and the higher CSI-RS part, if any. As illustrated in the example 1500, the derived CSI-RS resource is characterized by a start RB 1504 (Start RB #0) and nrOfRBs 1506=(Start RB #1 (if any)+noOfRBs #1 (if any))−Start RBs #0.

In one or more implementations, the UE receives an option indication that indicates which of these options to apply for deriving the single CSI-RS resource during Dl-only symbols or slots. In some examples, the option indication is provided within the RRC configuration message. In some other examples, the option indication is provided dynamically via a DCI message. In yet other examples, the option indication is associated with at least one of a time pattern, a time window, or a time index set.

Accordingly, to enhance flexibility of CSI-RS frequency allocation during SBFD symbols, in one or more implementations, a CSI-RS resource intended for SBFD symbols includes multiple parts. A bitmap may be used to indicate which parts of the CSI-RS resources are active and used when deriving a single non-contiguous CSI-RS resource. The bitmap is provided, for example, via a RRC message and/or a DCI message, and is associated with at least one of a time pattern, a time window, or a time index set. In some aspects, the frequency resources of one or more parts of the CSI-RS resource are not confined within the associated DL subband and thus are excluded when deriving the single non-contiguous CSI-RS resource.

To generalize the CSI-RS frequency allocation between SBFD symbols and DL-only symbols, in one or more implementations, a CSI-RS resource is intended for SBFD symbols and DL-only symbols and includes multiple parts. Different options are provided and used by the UE when deriving the single CSI-RS resource from indicated CSI-RS parts. In some aspects, the UE is provided with an option indication indicating which option to apply for deriving the single CSI-RS resource during Dl-only symbols or slots. The option indication is provided, for example, via a RRC message and/or a DCI message, and is associated with at least one of a time pattern, a time window, or a time index set.

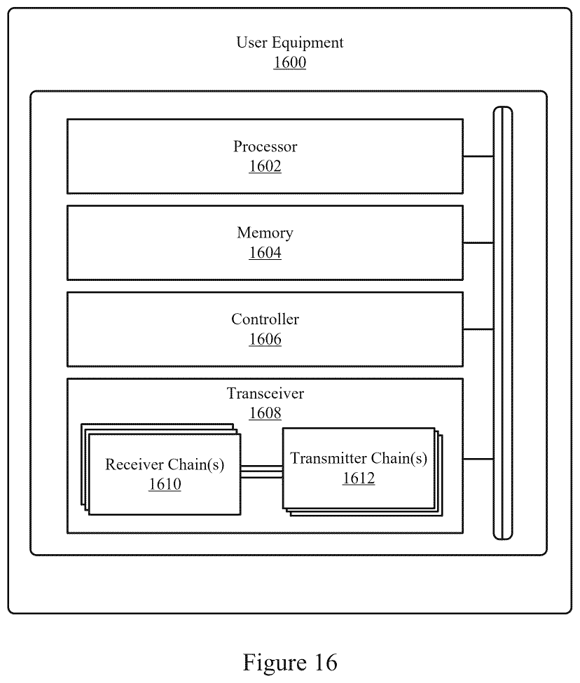

FIG. 16 illustrates an example of a UE 1600 in accordance with aspects of the present disclosure. The UE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the UE 1600 to perform various functions of the present disclosure.

The memory 1604 may include volatile or non-volatile memory. The memory 1604 may store computer-readable, computer-executable code including instructions when executed by the processor 1602 cause the UE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to or operable to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to or operable to support a means for receiving a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband; and transmitting, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the UE 1600 may be configured to or operable to support any one or combination of where the active CSI-RS parts are indicated via a bitmap or by assuming all configured CSI-RS parts are active; where the bitmap is associated with one or both of SBFD symbols or DL symbols; receiving the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; deriving the second CSI-RS frequency resource during the DL symbol using a same techniques as used to derive the first CSI-RS frequency resource during the SBFD symbol; deriving the second CSI-RS frequency resource during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts; where the lower CSI-RS part is one of the multiple active CSI-RS parts associated with a minimum start RB; deriving the second CSI-RS frequency resource during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; receiving an option indication that indicates which of multiple options to use to derive the second CSI-RS frequency resource during the DL symbols; receiving the option indication via a RRC message or a DCI message; where the option indication is associated with at least one of a time pattern, a time window, or a time index set.

Additionally, or alternatively, the UE 1600 may support at least one memory (e.g., the memory 1604) and at least one processor (e.g., the processor 1602) coupled with the at least one memory and configured to or operable to cause the UE to: receive a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband; transmit, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the UE 1600 may be configured to or operable to support any one or combination of the at least one processor is configured to or operable to where the active CSI-RS parts are indicated via a bitmap or by assuming all configured CSI-RS parts are active; where the bitmap is associated with one or both of SBFD symbols or DL symbols; where the at least one processor is further configured to or operable to cause the UE to receive the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; where the at least one processor is further configured to or operable to cause the UE to derive the second CSI-RS frequency resource during the DL symbol using a same techniques as used to derive the first CSI-RS frequency resource during the SBFD symbol; where the at least one processor is further configured to or operable to cause the UE to derive the second CSI-RS frequency resource during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts; where the lower CSI-RS part is one of the multiple active CSI-RS parts associated with a minimum start RB; where the at least one processor is further configured to or operable to cause the UE to derive the second CSI-RS frequency resource during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; where the at least one processor is further configured to or operable to cause the UE to receive an option indication that indicates which of multiple options to use to derive the second CSI-RS frequency resource during the DL symbols; where the at least one processor is further configured to or operable to cause the UE to receive the option indication via a RRC message or a DCI message; where the option indication is associated with at least one of a time pattern, a time window, or a time index set.

The controller 1606 may manage input and output signals for the UE 1600. The controller 1606 may also manage peripherals not integrated into the UE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the UE 1600 may include at least one transceiver 1608. In some other implementations, the UE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

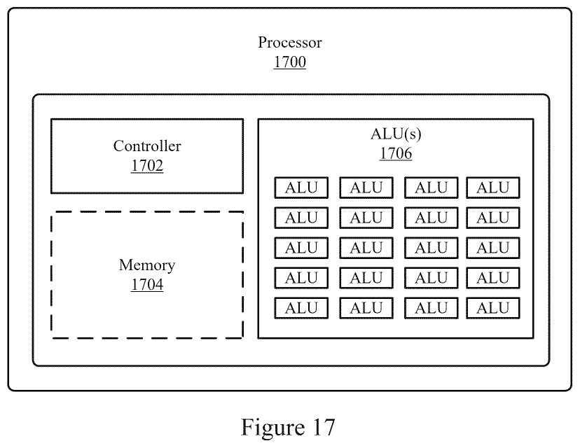

FIG. 17 illustrates an example of a processor 1700 in accordance with aspects of the present disclosure. The processor 1700 may be an example of a processor configured to perform various operations in accordance with examples as described herein. The processor 1700 may include a controller 1702 configured to perform various operations in accordance with examples as described herein. The processor 1700 may optionally include at least one memory 1704, which may be, for example, an L1/L2/L3 cache. Additionally, or alternatively, the processor 1700 may optionally include one or more arithmetic-logic units (ALUs) 1706. One or more of these components may be in electronic communication or otherwise coupled (e.g., operatively, communicatively, functionally, electronically, electrically) via one or more interfaces (e.g., buses).

The processor 1700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1702 may be configured to manage and coordinate various operations (e.g., signaling, receiving, obtaining, retrieving, transmitting, outputting, forwarding, storing, determining, identifying, accessing, writing, reading) of the processor 1700 to cause the processor 1700 to support various operations in accordance with examples as described herein. For example, the controller 1702 may operate as a control unit of the processor 1700, generating control signals that manage the operation of various components of the processor 1700. These control signals include enabling or disabling functional units, selecting data paths, initiating memory access, and coordinating timing of operations.

The controller 1702 may be configured to fetch (e.g., obtain, retrieve, receive) instructions from the memory 1704 and determine subsequent instruction(s) to be executed to cause the processor 1700 to support various operations in accordance with examples as described herein. The controller 1702 may be configured to track memory addresses of instructions associated with the memory 1704. The controller 1702 may be configured to decode instructions to determine the operation to be performed and the operands involved. For example, the controller 1702 may be configured to interpret the instruction and determine control signals to be output to other components of the processor 1700 to cause the processor 1700 to support various operations in accordance with examples as described herein. Additionally, or alternatively, the controller 1702 may be configured to manage flow of data within the processor 1700. The controller 1702 may be configured to control transfer of data between registers, ALUs 1706, and other functional units of the processor 1700.

The memory 1704 may include one or more caches (e.g., memory local to or included in the processor 1700 or other memory, such as RAM, ROM, DRAM, SDRAM, SRAM, MRAM, flash memory, etc. In some implementations, the memory 1704 may reside within or on a processor chipset (e.g., local to the processor 1700). In some other implementations, the memory 1704 may reside external to the processor chipset (e.g., remote to the processor 1700).

The memory 1704 may store computer-readable, computer-executable code including instructions that, when executed by the processor 1700, cause the processor 1700 to perform various functions described herein. The code may be stored in a non-transitory computer-readable medium such as system memory or another type of memory. The controller 1702 and/or the processor 1700 may be configured to execute computer-readable instructions stored in the memory 1704 to cause the processor 1700 to perform various functions. For example, the processor 1700 and/or the controller 1702 may be coupled with or to the memory 1704, the processor 1700, and the controller 1702, and may be configured to perform various functions described herein. In some examples, the processor 1700 may include multiple processors and the memory 1704 may include multiple memories. One or more of the multiple processors may be coupled with one or more of the multiple memories, which may, individually or collectively, be configured to perform various functions herein.

The one or more ALUs 1706 may be configured to support various operations in accordance with examples as described herein. In some implementations, the one or more ALUs 1706 may reside within or on a processor chipset (e.g., the processor 1700). In some other implementations, the one or more ALUs 1706 may reside external to the processor chipset (e.g., the processor 1700). One or more ALUs 1706 may perform one or more computations such as addition, subtraction, multiplication, and division on data. For example, one or more ALUs 1706 may receive input operands and an operation code, which determines an operation to be executed. One or more ALUs 1706 may be configured with a variety of logical and arithmetic circuits, including adders, subtractors, shifters, and logic gates, to process and manipulate the data according to the operation. Additionally, or alternatively, the one or more ALUs 1706 may support logical operations such as AND, OR, exclusive-OR (XOR), not-OR (NOR), and not-AND (NAND), enabling the one or more ALUs 1706 to handle conditional operations, comparisons, and bitwise operations.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to or operable to cause the processor to: receive a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband; transmit, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the processor 1700 may be configured to or operable to support any one or combination of the at least one controller is configured to or operable to cause the processor to the active CSI-RS parts are indicated via a bitmap or by assuming all configured CSI-RS parts are active; where the bitmap is associated with one or both of SBFD symbols or DL symbols; where the at least one controller is further configured to or operable to cause the processor to receive the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; where the at least one controller is further configured to or operable to cause the processor to derive the second CSI-RS frequency resource during the DL symbol using a same techniques as used to derive the first CSI-RS frequency resource during the SBFD symbol; where the at least one controller is further configured to or operable to cause the processor to derive the second CSI-RS frequency resource during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts; where the lower CSI-RS part is one of the multiple active CSI-RS parts associated with a minimum start RB; where the at least one controller is further configured to or operable to cause the processor to derive the second CSI-RS frequency resource during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; where the at least one controller is further configured to or operable to cause the processor to receive an option indication that indicates which of multiple options to use to derive the second CSI-RS frequency resource during the DL symbols; where the at least one controller is further configured to or operable to cause the processor to receive the option indication via a RRC message or a DCI message; where the option indication is associated with at least one of a time pattern, a time window, or a time index set.

The processor 1700 may support wireless communication in accordance with examples as disclosed herein. The processor 1700 may be configured to or configured to or operable to support at least one controller (e.g., the controller 1702) coupled with at least one memory (e.g., the memory 1704) and configured to or configured to or operable to cause the processor to: transmit, to a UE, a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband, receive, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the processor 1700 may be configured to or operable to support any one or combination of where the active CSI-RS parts are indicated via a bitmap or by assuming all configured CSI-RS parts are active; where the bitmap is associated with one or both of SBFD symbols or DL symbols; where the at least one processor is further configured to or operable to cause the base station to transmit the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; where the second CSI-RS frequency resource is derived during the DL symbol using a same techniques as used to derive the first CSI-RS frequency resource during the SBFD symbol; where the second CSI-RS frequency resource is derived during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts; where the lower CSI-RS part is one of the multiple active CSI-RS parts associated with a minimum start RB; where the second CSI-RS frequency resource is derived during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; where the at least one processor is further configured to or operable to cause the base station to transmit an option indication that indicates which of multiple options to use to derive the second CSI-RS frequency resource during the DL symbols; where the at least one processor is further configured to or operable to cause the base station to transmit the option indication via a RRC message or a DCI message; where the option indication is associated with at least one of a time pattern, a time window, or a time index set.

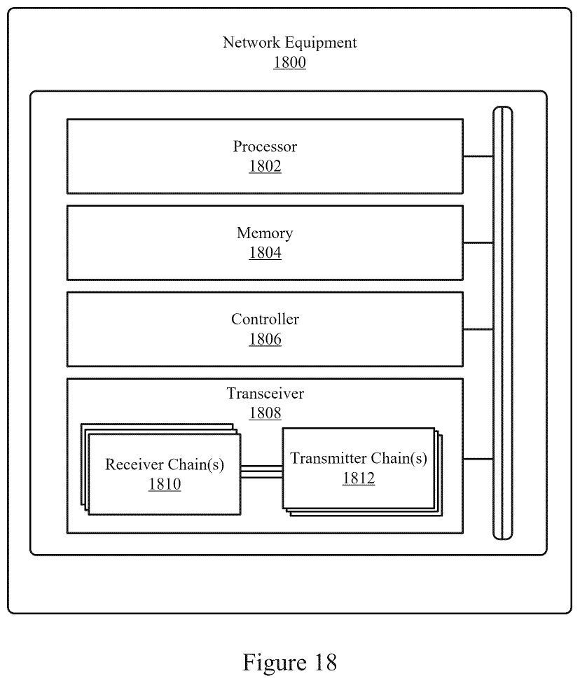

FIG. 18 illustrates an example of an NE 1800 in accordance with aspects of the present disclosure. The NE 1800 may include a processor 1802, a memory 1804, a controller 1806, and a transceiver 1808. The processor 1802, the memory 1804, the controller 1806, or the transceiver 1808, or various combinations thereof or various components thereof may be examples of means for performing various aspects of the present disclosure as described herein. These components may be coupled (e.g., operatively, communicatively, functionally, electronically, electrically) via one or more interfaces.

The processor 1802, the memory 1804, the controller 1806, or the transceiver 1808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1802 may include an intelligent hardware device (e.g., a general-purpose processor, a DSP, a CPU, an ASIC, an FPGA, or any combination thereof). In some implementations, the processor 1802 may be configured to operate the memory 1804. In some other implementations, the memory 1804 may be integrated into the processor 1802. The processor 1802 may be configured to execute computer-readable instructions stored in the memory 1804 to cause the NE 1800 to perform various functions of the present disclosure.

The memory 1804 may include volatile or non-volatile memory. The memory 1804 may store computer-readable, computer-executable code including instructions when executed by the processor 1802 cause the NE 1800 to perform various functions described herein. The code may be stored in a non-transitory computer-readable medium such as the memory 1804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1802 and the memory 1804 coupled with the processor 1802 may be configured to or operable to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to or operable to support a means for transmitting, to a UE, a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband; and receiving, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the NE 1800 may be configured to or operable to support any one or combination of where the active CSI-RS parts are indicated via a bitmap or by assuming all configured or operable to CSI-RS parts are active; where the bitmap is associated with one or both of SBFD symbols or DL symbols; transmitting the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; where the second CSI-RS frequency resource is derived during the DL symbol using a same techniques as used to derive the first CSI-RS frequency resource during the SBFD symbol; where the second CSI-RS frequency resource is derived during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts; where the lower CSI-RS part is one of the multiple active CSI-RS parts associated with a minimum start RB; where the second CSI-RS frequency resource is derived during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; transmitting an option indication that indicates which of multiple options to use to derive the second CSI-RS frequency resource during the DL symbols; transmitting the option indication via a RRC message or a DCI message; where the option indication is associated with at least one of a time pattern, a time window, or a time index set.

Additionally, or alternatively, the NE 1800 may support at least one memory (e.g., the memory 1804) and at least one processor (e.g., the processor 1802) coupled with the at least one memory and configured to or operable to cause the NE to: transmit, to a UE, a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband; receive, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

Additionally, the NE 1800 may be configured to or operable to support any one or combination of the at least one processor is configured to or operable to cause the NE to where the active CSI-RS parts are indicated via a bitmap or by assuming all configured CSI-RS parts are active; where the bitmap is associated with one or both of SBFD symbols or DL symbols; where the at least one processor is further configured to or operable to cause the base station to transmit the bitmap via a RRC message or a DCI message; where the bitmap is associated with at least one of a time pattern, a time window, or a time index set; where frequency resources of one or more of CSI-RS parts not confined within an associated DL subband are excluded when deriving the first CSI-RS frequency resource during the SBFD symbol; where an association between a CSI-RS part of the multiple active CSI-RS parts and a DL subband of a SBFD symbol is determined based at least in part on a location of a start RB of the CSI-RS part; where the second CSI-RS frequency resource is derived during the DL symbol using a same techniques as used to derive the first CSI-RS frequency resource during the SBFD symbol; where the second CSI-RS frequency resource is derived during the DL symbol by combining the multiple active CSI-RS parts; where the second CSI-RS frequency resource derived during the DL symbol is characterized by a start RB of a lower CSI-RS part of the multiple active CSI-RS parts and a number of RBs calculated by summing a number of RBs of the multiple active CSI-RS parts, where the lower CSI-RS part is one of the multiple active CSI-RS parts associated with a minimum start RB; where the second CSI-RS frequency resource is derived during the DL symbol by including frequency resources between lower a CSI-RS part of the multiple active CSI-RS parts and higher CSI-RS part of the multiple active CSI-RS parts; where the lower CSI-RS part is one of the multiple active CSI-RS parts associated with a minimum start RB and the higher CSI-RS part is one of the multiple active CSI-RS parts associated with a highest RB index; where the derived second CSI-RS frequency resource derived during the DL symbol is characterized by a start RB of a lower CSI-RS part of the multiple active CSI-RS parts and a number of RBs calculated from a start RB of a higher CSI-RS part of the multiple active CSI-RS parts; where the number of RBs is calculated based at least in part on a number of RBs of a higher CSI-RS part of the multiple active CSI-RS parts, and a start RB of a lower CSI-RS part of the multiple active CSI-RS parts; where the at least one processor is further configured to or operable to cause the base station to transmit an option indication that indicates which of multiple options to use to derive the second CSI-RS frequency resource during the DL symbols; where the at least one processor is further configured to or operable to cause the base station to transmit the option indication via a RRC message or a DCI message; where the option indication is associated with at least one of a time pattern, a time window, or a time index set.

The controller 1806 may manage input and output signals for the NE 1800. The controller 1806 may also manage peripherals not integrated into the NE 1800. In some implementations, the controller 1806 may utilize an operating system such as iOS®, ANDROID®, WINDOWS®, or other operating systems. In some implementations, the controller 1806 may be implemented as part of the processor 1802.

In some implementations, the NE 1800 may include at least one transceiver 1808. In some other implementations, the NE 1800 may have more than one transceiver 1808. The transceiver 1808 may represent a wireless transceiver. The transceiver 1808 may include one or more receiver chains 1810, one or more transmitter chains 1812, or a combination thereof.

A receiver chain 1810 may be configured to receive signals (e.g., control information, data, packets) over a wireless medium. For example, the receiver chain 1810 may include one or more antennas to receive a signal over the air or wireless medium. The receiver chain 1810 may include at least one amplifier (e.g., a low-noise amplifier (LNA)) configured to amplify the received signal. The receiver chain 1810 may include at least one demodulator configured to demodulate the receive signal and obtain the transmitted data by reversing the modulation technique applied during transmission of the signal. The receiver chain 1810 may include at least one decoder for decoding the demodulated signal to receive the transmitted data.

A transmitter chain 1812 may be configured to generate and transmit signals (e.g., control information, data, packets). The transmitter chain 1812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1812 may also include at least one power amplifier configured to amplify the modulated signal to an appropriate power level suitable for transmission over the wireless medium. The transmitter chain 1812 may also include one or more antennas for transmitting the amplified signal into the air or wireless medium.

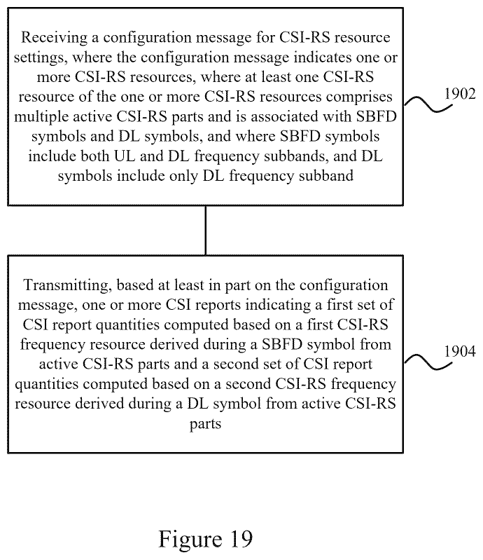

FIG. 19 illustrates a flowchart of a method in accordance with aspects of the present disclosure. The operations of the method may be implemented by a UE as described herein. In some implementations, the UE may execute a set of instructions to control the function elements of the UE to perform the described functions.

At 1902, the method may include receiving a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband. The operations of 1902 may be performed in accordance with examples as described herein. In some implementations, aspects of the operations of 1902 may be performed by a UE as described with reference to FIG. 16.

At 1904, the method may include transmitting, based at least in part on the configuration message, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts. The operations of 1904 may be performed in accordance with examples as described herein. In some implementations, aspects of the operations of 1904 may be performed by a UE as described with reference to FIG. 16.

It should be noted that the method described herein describes a possible implementation, and that the operations and the steps may be rearranged or otherwise modified and that other implementations are possible.

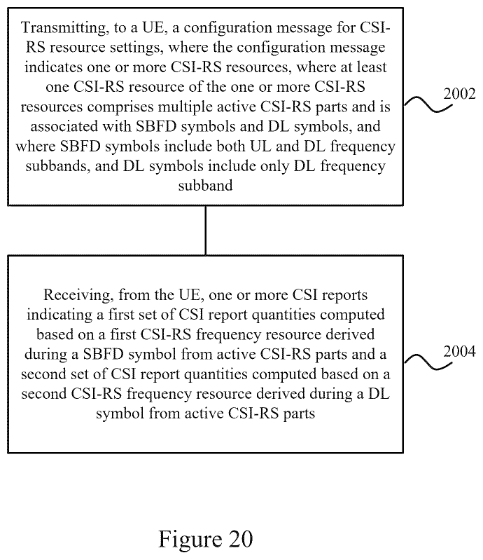

FIG. 20 illustrates a flowchart of a method in accordance with aspects of the present disclosure. The operations of the method may be implemented by an NE as described herein. In some implementations, the NE may execute a set of instructions to control the function elements of the NE to perform the described functions.

At 2002, the method may include transmitting, to a UE, a configuration message for CSI-RS resource settings, where the configuration message indicates one or more CSI-RS resources, where at least one CSI-RS resource of the one or more CSI-RS resources comprises multiple active CSI-RS parts and is associated with SBFD symbols and DL symbols, and where SBFD symbols include both UL and DL frequency subbands, and DL symbols include only DL frequency subband. The operations of 2002 may be performed in accordance with examples as described herein. In some implementations, aspects of the operations of 2002 may be performed by an NE as described with reference to FIG. 18.

At 2004, the method may include receiving, from the UE, one or more CSI reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts. The operations of 2004 may be performed in accordance with examples as described herein. In some implementations, aspects of the operations of 2004 may be performed by an NE as described with reference to FIG. 18.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a configuration message for channel state information reference signal (CSI-RS) resource settings, wherein the configuration message indicates one or more CSI-RS resources, wherein at least one CSI-RS resource of the one or more CSI-RS resources comprises multiple active CSI-RS parts and is associated with subband full-duplex (SBFD) symbols and downlink (DL) symbols, and wherein SBFD symbols include both uplink (UL) and DL frequency subbands, and DL symbols include only DL frequency subband;
transmit, based at least in part on the configuration message, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

2. The UE of claim 1, wherein the active CSI-RS parts are indicated via a bitmap or by assuming all configured CSI-RS parts are active.

3. The UE of claim 2, wherein the bitmap is associated with one or both of SBFD symbols or DL symbols.

4. The UE of claim 2, wherein the at least one processor is further operable to cause the UE to receive the bitmap via a radio resource control (RRC) message or a DL control information (DCI) message.

5. The UE of claim 2, wherein the bitmap is associated with at least one of a time pattern, a time window, or a time index set.

6. The UE of claim 1, wherein frequency resources of one or more of CSI-RS parts not confined within an associated DL subband are excluded when deriving the first CSI-RS frequency resource during the SBFD symbol.

7. The UE of claim 1, wherein an association between a CSI-RS part of the multiple active CSI-RS parts and a DL subband of a SBFD symbol is determined based at least in part on a location of a start resource block (RB) of the CSI-RS part.

8. The UE of claim 1, wherein the at least one processor is further operable to cause the UE to derive the second CSI-RS frequency resource during the DL symbol using a same techniques as used to derive the first CSI-RS frequency resource during the SBFD symbol.

9. The UE of claim 1, wherein the at least one processor is further operable to cause the UE to derive the second CSI-RS frequency resource during the DL symbol by combining the multiple active CSI-RS parts.

10. The UE of claim 9, wherein the second CSI-RS frequency resource derived during the DL symbol is characterized by a start resource block (RB) of a lower CSI-RS part of the multiple active CSI-RS parts and a number of RBs calculated by summing a number of RBs of the multiple active CSI-RS parts.

11. The UE of claim 10, wherein the lower CSI-RS part is one of the multiple active CSI-RS parts associated with a minimum start RB.

12. The UE of claim 1, wherein the at least one processor is further operable to cause the UE to derive the second CSI-RS frequency resource during the DL symbol by including frequency resources between lower a CSI-RS part of the multiple active CSI-RS parts and higher CSI-RS part of the multiple active CSI-RS parts.

13. The UE of claim 12, wherein the lower CSI-RS part is one of the multiple active CSI-RS parts associated with a minimum start RB and the higher CSI-RS part is one of the multiple active CSI-RS parts associated with a highest RB index.

14. The UE of claim 12, wherein the derived second CSI-RS frequency resource derived during the DL symbol is characterized by a start resource block (RB) of a lower CSI-RS part of the multiple active CSI-RS parts and a number of RBs calculated from a start RB of a higher CSI-RS part of the multiple active CSI-RS parts.

15. The UE of claim 14, wherein the number of RBs is calculated based at least in part on a number of RBs of a higher CSI-RS part of the multiple active CSI-RS parts, and a start RB of a lower CSI-RS part of the multiple active CSI-RS parts.

16. The UE of claim 1, wherein the at least one processor is further operable to cause the UE to receive an option indication that indicates which of multiple options to use to derive the second CSI-RS frequency resource during the DL symbols.

17. A base station for wireless communication, comprising:
at least one memory; and
at least one processor coupled with the at least one memory and operable to cause the base station to:
transmit, to a user equipment (UE), a configuration message for channel state information reference signal (CSI-RS) resource settings, wherein the configuration message indicates one or more CSI-RS resources, wherein at least one CSI-RS resource of the one or more CSI-RS resources comprises multiple active CSI-RS parts and is associated with subband full-duplex (SBFD) symbols and downlink (DL) symbols, and wherein SBFD symbols include both uplink (UL) and DL frequency subbands, and DL symbols include only DL frequency subband;
receive, from the UE, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

18. The base station of claim 17, wherein frequency resources of one or more of CSI-RS parts not confined within an associated DL subband are excluded when deriving the first CSI-RS frequency resource during the SBFD symbol.

19. A method performed by a user equipment (UE), the method comprising:
receiving a configuration message for channel state information reference signal (CSI-RS) resource settings, wherein the configuration message indicates one or more CSI-RS resources, wherein at least one CSI-RS resource of the one or more CSI-RS resources comprises multiple active CSI-RS parts and is associated with subband full-duplex (SBFD) symbols and downlink (DL) symbols, and wherein SBFD symbols include both uplink (UL) and DL frequency subbands, and DL symbols include only DL frequency subband; and
transmitting, based at least in part on the configuration message, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.

20. A method performed by a base station, the method comprising:
transmitting, to a user equipment (UE), a configuration message for channel state information reference signal (CSI-RS) resource settings, wherein the configuration message indicates one or more CSI-RS resources, wherein at least one CSI-RS resource of the one or more CSI-RS resources comprises multiple active CSI-RS parts and is associated with subband full-duplex (SBFD) symbols and downlink (DL) symbols, and wherein SBFD symbols include both uplink (UL) and DL frequency subbands, and DL symbols include only DL frequency subband; and
receiving, from the UE, one or more channel state information (CSI) reports indicating a first set of CSI report quantities computed based on a first CSI-RS frequency resource derived during a SBFD symbol from active CSI-RS parts and a second set of CSI report quantities computed based on a second CSI-RS frequency resource derived during a DL symbol from active CSI-RS parts.
